(19) United States
(12) Patent Application Publication
(10) Pub. No.: US 2008/0210773 A1
(43) Pub. Date: Sep. 4, 2008

(54) Fuel Injection Device for Internal Combustion Engine

(75) Inventors: Nadim Malek, Versailles (FR); Andre Agneray, Boulogne (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT s.a.s, Boulogne (FR)

(21) Appl. No.: 11/996,454

(22) PCT Filed: Jul. 18, 2006
(86) PCT No.: PCT/FR2006/050725

§ 371 Date: Apr. 22, 2008

(30) Foreign Application Priority Data
Jul. 20, 2005 (FR) 0507714

(51) Int. Cl. B05B 1/08

(52) U.S. Cl. 239/102.2; 239/585.5

(57) ABSTRACT

A fuel injection device for an internal combustion engine. The fuel injection device includes an injecting head integral with an end of a needle mobile in translation inside an injection housing supplied with high pressure fuel and having a seat for the injecting head, and a piezoelectric or magnetoresistive vibratory element capable, when energized, to act on the needle, maintained by a return spring, to cause the needle to vibrate, such that the injecting head co-operates with its seat to periodically open and close a passage for fuel injection. A controller controls movement of the needle in translation, countering the return spring, independent of the vibratory element.

The present invention falls within the context of fuel injection devices for internal combustion engines, providing very finely atomized fuel. To this end, atomization fuel injection devices generally comprise a variable-frequency ultrasonic actuator, controlling the variation in frequency making it possible to control the translational movement of the needle. The ultrasonic frequency and the excitation amplitude of the actuator can be slaved to the pressure of the gases in the combustion chamber or to other parameters, thus making it possible to make the fuel delivery independent of the back pressure which develops once combustion has been initiated.

It is possible to use injection devices of this type on direct injection or indirect injection diesel engines, on homogeneous charge compression ignition engines (known as HCCI engines) and also on direct injection or indirect injection gasoline engines. In all cases, the desired objective by precise control over the excitation frequency of the actuator is to reduce emissions of pollutants, fuel consumption, and the creation of particles of soot. Injection devices of this type need also to make it easier for the combustion engine to run on lean or stratified mixtures.

A fuel injection device of this type which comprises, in an injection unit supplied with high-pressure fuel, a translationally moveable needle that can be given high-frequency oscillations under the action of an ultrasonic piezoelectric vibratory element comprising a stack of piezoelectric ceramic rings is known, for example from patent application 2 807 008 (RENAULT). This stack is installed inside the injection unit and, when excited, can impart a vibratory movement of alternating oscillations to a cylindrical body secured to the injection needle. The injection head situated at the end of the needle collaborates with a seat to determine a fuel injection passage, the opening, and therefore the fuel delivery, of which is defined by the oscillatory movement of the injection head.

A piezoelectric control element such as this may also be replaced by an ultrasonic magnetostrictive element using a rod of magnetostrictive material of the Terfenol D type or of any other material which has equivalent properties.

In both instances, the excitation imparted by the vibratory element to the needle causes oscillations of the needle that can be amplified when this needle is suitably matched, for example by quarter-wave matching.

It will, however, be observed that an injection device such as this has various disadvantages. Specifically, it is necessary to have perfect control over the oscillations of the injection head and over the various resonance effects in order precisely to control the injected fuel delivery. Any rubbing of the injection needle in its bore within the injection device or of the head in the cylinder head of the engine will have a significant impact on the injected fuel delivery. Likewise, a mismatch in the resonant frequency leads to a change in the position of the movement node during needle oscillations, thus altering the injected fuel delivery. In practice, it is found that it is difficult to have perfect control over these various parameters and to produce injection devices with identical performance and performance that does not vary over time.

It is an object of the present invention to solve these difficulties by producing a fuel injection device that allows better control over the injected fuel delivery, and that makes the delivery insensitive to the effects of thermal expansion. A further object of the invention is an injection device such as this that facilitates cold starts, that is to say the injection of fuel that is more viscous than would be the case during normal running of the combustion engine.

In one embodiment, the fuel injection device for an internal combustion engine, is of the type comprising an injection head secured to the end of a needle able to move translationally inside an injection unit supplied with high-pressure fuel. The unit has a seat for the injection head. A piezoelectric or magnetostrictive vibratory element is capable, when excited, of acting on the needle held by a return spring in order to set it into vibration. In this way, the injection head collaborates with its seat in order periodically to open and close a fuel injection passage. The device also comprises a control means for controlling the translational movement of the needle, which is independent of the control of the vibratory element.

The movement of the needle, which defines the injected fuel delivery, is controlled independently of the excitation of the vibratory element which for its part causes the high-frequency break up of the sheet of fuel, thereby atomizing the injected fuel.

By controlling the movement of the needle independently of the break up excitation in this way, it is possible to obtain more accurate and better controlled fuel delivery. The excitation frequency of the vibratory element for breaking up the sheet of injected fuel can be varied and there is no longer any need to optimize it in order to obtain a specific needle movement because the needle movement is controlled by a different means.

Control over the atomization using the high-frequency oscillations of the needle can also be initiated even before the needle has been made to move, and can be stopped afterwards.

Atomization controlled by high-frequency ultrasound can easily be tailored to the temperature of the fuel that is to be injected by altering the frequency of the oscillations. A cold start with a more viscous fuel therefore becomes easier to manage.

It also becomes easy to keep the injected fuel delivery perfectly constant in spite of thermal expansions of the components of the injection device by taking up the expansion clearances through control of the movement of the needle.

In one preferred embodiment, the means of controlling the movement of the needle comprises a piezoelectric or magnetostrictive element which can be excited independently of the vibratory element that generates the oscillations of the needle.

The needle may advantageously be mounted at the end of a body of cylindrical overall shape forming part of an assembly capable of translational movement inside the injection unit. The piezoelectric or magnetostrictive vibratory element which generates the oscillations of the needle and breaks up the sheet of injected fuel forms an integral part of this moving assembly which also comprises a damping mass designed to define the resonant frequency of the assembly.

In one embodiment, the piezoelectric or magnetostrictive element of the means of controlling the translational movement of the needle is secured to the moving assembly.

In another embodiment, the moving assembly comprises a part forming a piston, able to move in a hydraulic control chamber which is supplied with high-pressure fuel. The control chamber communicates with the low-pressure fuel return via a dump valve actuated by the control means. By varying the position of the dump valve it is thus possible to alter the pressure in the control chamber, thus causing the piston and the moving assembly to move.

The fuel injection passage may be opened through a deployment movement of the injection head relative to the injection unit. In this case, excitation of the piezoelectric or magnetostrictive element of the control means causes the dump valve to close.

As an alternative, the fuel injection passage is opened through a retraction movement of the injection head relative to the injection unit. In this case, excitation of the piezoelectric or magnetostrictive element of the control means causes the dump valve to open.

The needle is generally secured to a shoulder of the cylindrical body capable of sliding in a housing of the injection unit thereby ensuring a very small fluid leakage. A flow limiter is thus defined for the pressurized fuel which escapes within the injection unit toward a return duct.

High-pressure fuel supply and low-pressure fuel return ducts are advantageously provided in the injection unit, for example in the unit wall thickness.

The invention will be better understood from studying the detailed description of a number of embodiments which are taken by way of nonlimiting examples and illustrated by the attached drawings in which:

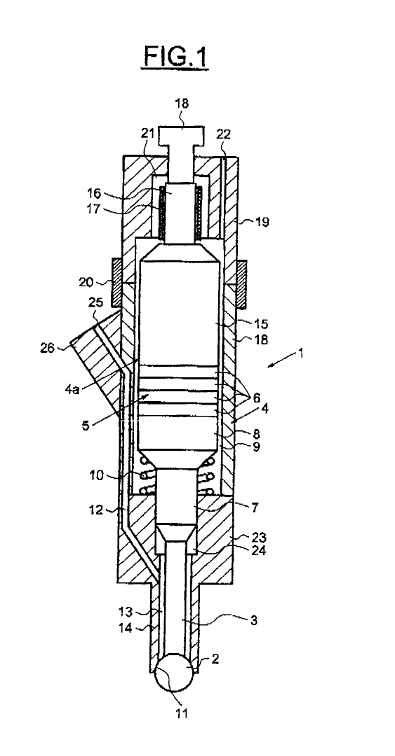

FIG. 1 is a sectioned schematic depiction of a first embodiment of a fuel injection device according to the invention;

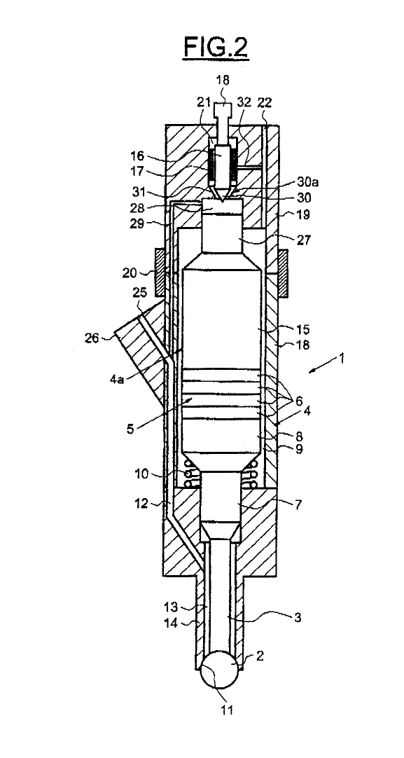

FIG. 2 is a similar sectioned view of a second embodiment of a device according to the invention; and

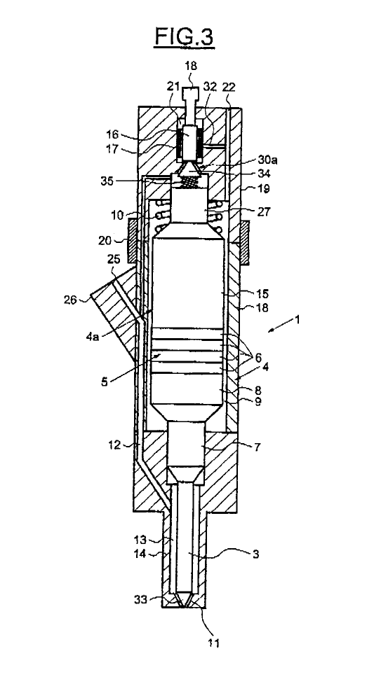

FIG. 3 is a similar sectioned view of a third embodiment of a device according to the invention.

As depicted in FIG. 1, the fuel injection device, referenced 1 in its entirety, comprises an injection head 2 secured to the end of a needle 3 capable of translational movement inside an injection unit 4. A piezoelectric vibratory element 5 comprises a stack of four ceramic rings 6 made of piezoelectric material.

The needle 3 is secured to a shoulder 7 which extends toward the needle 3 a cylindrical body 8 the diameter of which is matched to the internal cavity of the injection unit 4, so as to leave a clearance between the cylindrical body 8 mounted inside a chamber 9 and the wall of the unit 4. A return spring 10 acts on the cylindrical body 8 in such a way as to move it in the direction that presses the injection head 2 onto its seat 11, that is to say that closes the fuel injection passage. The fuel is introduced at high pressure via a supply duct 12 which passes longitudinally through the wall of the unit 4 and ends in a space 13 that remains between the needle 3 and a guide 14 at the end of which the seat 11 is defined.

Mounted above the cylindrical body 8 is the stack of piezoelectric ceramics 6 which defines the vibratory element 5. Mounted above the vibratory element 5 is a damping mass 15 which has a cylindrical overall shape of the same diameter as the cylindrical body 8 and the various piezo electric rings 6. The assembly formed by the needle 3, the shoulder 7, the cylindrical body 8, the vibratory element 5 and the damping mass 15 constitutes a moving assembly 4a capable of translational movement inside the injection unit 4.

Mounted in the upper part of this assembly 4a and fixed to the damping mass 15 is a magnetostrictive rod 16 which constitutes a means of controlling the movement of the assembly 4a and therefore of the needle 3. To do this, the rod 16 is mounted inside an excitation solenoid 17. The magnetostrictive rod 16 is also secured to an immobilizing element 18 which secures it in the injection unit 4.

It will be noted that, in order to allow the various elements that make up the injection device 1 to be assembled, the unit 4 is made in several parts. The unit 4 in effect comprises a central part 18 that defines the chamber 9 inside which the assembly 4a comprising the cylindrical body 8, the vibratory element 5 and the damping mass 15 can move. Mounted above this central part 18 is an upper cap 19 which is held on the central part 18 by means of a clamping ring 20. The upper cap 19 comprises a central housing 21 which houses the solenoid 17 and the magnetostrictive rod 16. In addition, the wall of the upper cap 19 is pierced with a duct 22 which is in communication with the chamber 9 and allows for the low-pressure return of uninjected fuel.

In the bottom part of the injection device 1, the unit 4 is completed by a lower piece 23 which has a central housing 24 inside which the shoulder 7 can effect a translational movement. The housing 24 defines a flow-limiting means for the uninjected fuel which can escape upward into the clearance there is between the shoulder 7 and the housing 24 and then by passing via the chamber 9 as far as the return duct 22.

The pressurized-fuel supply duct 12 has an inlet portion 25 made in a lateral block 26 secured to the central portion 18 of the injection unit 4.

In operation, the pressurized fuel is supplied via the duct 12. The piezoelectric elements 6 are supplied with electrical current by means which have not been depicted in the figure, at ultrasonic high frequency, so as to give rise to high-frequency oscillations of the needle 3 and of the injection head 2. It will be noted that the injection head 2 here is produced in the form of a ball approximately halt of which protrudes from its seat 11. The head may have some other shape.

The ultrahigh frequency oscillations of the head 2 break up the sheet of injected fuel, which is thus atomized into the form of very fine droplets.

In addition, the supply of electrical current to the excitation solenoid 17 causes a magnetic field to form inside said solenoid, and therefore causes the rod 16 to lengthen through a magnetostrictive effect. This lengthening gives rise to a downward thrust on the assembly 4a formed by the damping mass 15, the vibratory element 5, the cylindrical body 8, the shoulder 7 and the needle 3. This downward translational movement moves the head 2 off its seat 11 and increases the injected fuel delivery.

By providing independent supplies of electrical current to the solenoid 17 on the one hand, and the piezoelectric elements 6 on the other hand, it is possible entirely independently of one another to control the movement of the needle 3, which controls the injected fuel delivery, on the one hand, and the frequency of oscillation of the injection head 2 on the other hand, which controls the break up of the sheet of injected fuel.

It will be noted that excitation of the piezoelectric elements 6 causes oscillations of the needle 3 which may be amplified by suitably matching the various components, for example using quarter-wave matching, taking the resonant frequency of the needle 3, of the shoulder 7, of the cylindrical body 8 and of the damping mass 15 into consideration.

By virtue of the device of the invention, the needle is made to move solely by the magnetostrictive rod 16, while the break-up of the sheet of fuel leading to atomization of the injected fuel can be optimized by separate excitation.

Although in the example illustrated the vibratory element 5 is of the piezoelectric type, it will be understood that it is also possible to imagine the use of a magnetostrictive element in order to obtain the same oscillations. Likewise, instead of using the magnetostrictive rod 16 to cause the translational movement of the needle 3, it would be possible to use a piezoelectric device.

The embodiment illustrated in FIG. 2, in which components which are similar bear the same references, differs from the embodiment illustrated in FIG. 1 through the way in which the magnetostrictive rod 16 works. Specifically, in the embodiment illustrated in FIG. 2, a piston-forming cylindrical part 27 is mounted at the upper end of the damping mass 15. The piston 27 is able to move in a hydraulic control chamber 28 which is supplied with pressurized fuel by a branch 29 connected to the pressurized-fuel supply duct 25.

The magnetostrictive rod 16 and the excitation solenoid 17 are not, like they were in the embodiment illustrated in FIG. 1, secured to the moving assembly 4a comprising the needle 3. Instead, the lower end 30 of the rod 16 comprises a component of conical shape which can collaborate with a seat 31, also of conical shape, formed in the upper cap 19 and defining a passage for the pressurized fuel that lies in the control chamber 28. The assembly comprising the end 30 and the seat 31 therefore constitutes a fuel dump valve 30a. When the dump valve 30a is open, pressurized fuel can enter the chamber 21 and then, via a duct 32 communicating with the return duct 22, be returned at low pressure to the fuel tank.

Excitation of the magnetostrictive rod 16 by the solenoid 17 may, as in the previous embodiment, cause the magnetostrictive rod 16 to expand, leading to a downward movement of the conical end 30, thus tending to close the dump valve 30a by reducing the leakage passage for pressurized fuel lying in the control chamber 28. This results in an increase in the pressure in said chamber 28, which causes thrust on the piston 27 and a downward translational movement of the moving assembly 4a consisting of the damping mass 15, the vibratory element 5, the shoulder 7, the cylindrical body 8 and the needle 3. The fuel injection passage is therefore increased by the downward movement of the injection head 2.

As in the previous embodiment, the stack of piezoelectric rings 6 that forms the vibratory element 5 may be supplied with electrical current at an ultrahigh frequency, thus imparting to the needle 3 and the injection head 2 an ultrahigh-frequency alternating movement that periodically closes and opens the inlet for the fuel which is broken up into very fine droplets.

When no power is supplied to the solenoid 17, the rod 16 contracts, thus opening the dump valve 30a and increasing the leakage passage between the end 30 and its seat 31. The fuel can therefore escape more easily from the hydraulic control chamber 28 to access the low-pressure return line 22. The piston 27, being subjected to a lower pressure, is no longer able to oppose the upward force exerted by the return spring 10, and this means that the needle 3 lifts and the injection head 2 closes the injection passage. Just as in the first figure, the vibratory actuator may be embodied using a magnetostrictive element.

In both embodiments illustrated in FIGS. 1 and 2, the injection head 2 is of the “deploying” type. It is through a downward (in the figures) translational movement of the needle 3 that it is possible to increase the injected fuel delivery.

The embodiment illustrated in FIG. 3 on the other hand shows a needle of the “retracting” type. The needle 3 in fact has an end 33 of conical shape which collaborates with the seat 11, here produced in conical shape. In this embodiment, it is an upward (in FIG. 3) translational movement of the needle 3 that increases the opening of the injection passage. The return spring 10 is therefore in this instance mounted in the upper part of the damping mass 15 and exerts a downward force that tends to lower the needle 3 and close off the fuel injection passage.

In the embodiment illustrated in FIG. 3, in which components which are similar bear the same references, control of the movement of the needle is had using hydraulic means, as in the embodiment of FIG. 2. We therefore see again, with the same layout, the piston-forming piece 27 capable of moving inside the hydraulic control chamber 28. However, because the movement for controlling the needle 3 has now to be reversed, the dump valve 30a is inverted here with respect to the arrangement used in the embodiment illustrated in FIG. 2. The magnetostrictive rod 16 is secured, via its lower end, to a frustoconical piece 34 against which there acts a return spring 35 which also bears against the upper face of the piston 27. The return spring 35 is housed in the hydraulic control chamber 28.

When the excitation solenoid 17 is powered with electrical current, the magnetostrictive rod 16 expands and moves its conical end 34 downward, this having the effect of opening the passage defined by the dump valve 30a by moving the frustoconical piece 34 off its seat 31.

This results in a greater leakage delivery for pressurized fuel in the hydraulic chamber 28 which escapes via the chamber 21 and the duct 32 in communication with the low-pressure return duct 22. This leads to a reduction in the pressure in the hydraulic chamber 28 which allows an upward movement of the piston 27 and therefore of the needle 3 which opens the injection passage via its end 33. The shoulder 7 acts as a piston to drive the assembly 4a upward.

It will of course have been understood that the return spring 10 needs to be selected such that it allows this upward movement of the moving assembly 4a comprising the piston 27, the needle 3 and the other elements in between, when there is a reduction in the hydraulic pressure in the control chamber 28. The return spring 35 for its part is able to stabilize the operation of the assembly, but could possibly be omitted.

It will be understood that the various means illustrated in the examples above for causing a translational movement of the needle 3 could, in each instance, be tailored to the type of needle, whether the needle be of the deploying or retracting type. In other words, it would be possible to fit the magnetostrictive rod illustrated in FIG. 1 to an injection device as illustrated in FIG. 3. It is, for example, by reducing the supply of power to the excitation solenoid 17 that it would then be possible to cause the magnetostrictive rod to contract, thus causing the needle to move upward.

1-9. (canceled)

10. A fuel injection device for an internal combustion engine, comprising:
an injection head secured to an end of a needle configured to move translationally inside an injection unit supplied with high-pressure fuel and including a seat for the injection head;
a piezoelectric or magnetostrictive vibratory element configured, when excited, to act on the needle held by a return spring to set the needle into vibration, such that the injection head collaborates with its seat to periodically open and close a fuel injection passage; and
control means for controlling the translational movement of the needle, against action of the return spring and independently of control of the vibratory element.

11. The injection device as claimed in claim 10, in which the means for controlling the translational movement of the needle comprises a piezoelectric or magnetostrictive element.

12. The injection device as claimed in claim 11, in which the needle is mounted at an end of a body of cylindrical overall shape forming part of an assembly configured for translational movement inside the injection unit, the assembly further comprising the piezoelectric or magnetostrictive vibratory element and a damping mass.

13. The injection device as claimed in claim 12, in which the piezoelectric or magnetostrictive element of the means for controlling the movement of the needle is secured to the assembly.

14. The injection device as claimed in claim 12, in which the assembly comprises a part forming a piston, configured to move in a hydraulic control chamber that is supplied with pressurized fuel, the chamber communicating with the low-pressure fuel return via a dump valve actuated by the control means.

15. The injection device as claimed in claim 14, in which the fuel injection passage is opened through a deployment movement of the injection head relative to the injection unit, excitation of the piezoelectric or magnetostrictive element of the control means causing the dump valve to close.

16. The injection device as claimed in claim 14, in which the fuel injection passage is opened through a retraction movement of the injection head relative to the injection unit, excitation of the piezoelectric or magnetostrictive element of the control means causing the dump valve to open.

17. The injection device as claimed in claim 10, in which the needle is secured to a shoulder of the cylindrical body configured to slide in a housing of the injection unit.

18. The injection device as claimed in claim 10, further comprising pressurized-fuel supply and low-pressure fuel return ducts.
